(19) United States
(12) Patent Application Publication
(10) Pub. No.: US 2012/0219738 A1
(43) Pub. Date: Aug. 30, 2012

(54) CONTAINER HAVING GROOVED FACETS

(75) Inventor: Michel Boukobza, Octeville Sur Mer (FR)

(73) Assignee: SIDEL PARTICIPATIONS, Octeville sur Mer (FR)

(21) Appl. No.: 13/394,079

(22) PCT Filed: Aug. 31, 2010
(86) PCT No.: PCT/FR2010/000596

§ 371 Date: May 14, 2012

(30) Foreign Application Priority Data
Sep. 4, 2009 (FR) 09/04205

(51) Int. Cl. B32B 1/02

(52) U.S. Cl. 428/35.7

(57) ABSTRACT

Container (1) of thermoplastic material such as PET, having a body (2) comprising at least one facet (6) defining a deformable membrane, delimited by a ridge (7) with closed contour, and in which an oblong groove (8) is made.

The invention relates to the domain of containers made of thermoplastic material such as PET, and more particularly, although not exclusively, containers such as bottles that can be filled hot.

A container is generally manufactured by the blowing or stretch-blowing of an injected preform, which is first heated by passing it through an oven provided with elements for heating by radiation, then inserted hot into a mold provided with a cavity defining the counter-impression of the container.

Although ordinary containers can be used for filling with cold liquids, they cannot withstand hot filling, due to insufficient mechanical strength. This results in significant deformations from the thermal shock that accompanies the filling.

By way of example, the temperature of the liquid during hot filling frequently exceeds 60° C., and commonly reaches 90° C. to 95° C. (i.e., a temperature exceeding the glass transition temperature of the PET).

Also, containers intended for hot filling (called heat-resistant, or HR) benefit from an appropriate manufacturing and from particular structural arrangements making them less sensitive to deformations and allowing them to sustainably preserve their general shape.

It is common to heat the wall of the mold in order to increase the rate of crystallinity of the polymer and thus increase the intrinsic rigidity of the material itself, independent of any structural characteristic of the container, but this feature of the manufacturing process is often insufficient for producing a satisfactory HR container, and it is necessary to make structural adaptations.

Since it is necessary to meet the economic and industrial demands for economy of material, thickening the wall of the container to make it stronger is not an option. On the contrary, the trend is to make it lighter.

This is the reason deformable zones for controlled deformation are generally provided on the container. Thus, it is known to provide the body of the container with panels that, during filling, will bulge out under the combined effect of the temperature and hydrostatic pressure, and which, when the liquid cools, will retract to accompany the reduction in volume of liquid, with the understanding that once the container is capped, this reduction in volume would not be compensated by the admission of an equivalent volume of air.

A good illustration of an HR container will be found in the French patent application FR 2 883 258 in the name of the applicant (see also its American equivalent US 2008/105645). The container is provided with a plurality of hollow panels, separated by beams and provided with reinforcing ribs. This type of container is satisfactory and it continues to be a commercial success. In its 0.5-L capacity version, this container weighs (empty) about 25 g, which is considered to be light since gains on the order of 3 g were achieved compared to previous containers whose weight, at equivalent capacity, was generally more than 28 g.

However, the pressure of the market continues to focus on an additional reduction of the quantity of material, and the applicant wishes to meet the demand by reducing the weight of containers even more, particularly HR containers, without reducing the performance with respect to mechanical strength.

To that end, the invention proposes a container, of thermoplastic material such as PET, having a body comprising at least one facet defining a deformable membrane, delimited by a ridge with closed contour and forming a salient angle on the body, an oblong groove being made in said facet.

Under the effect of stress from excess pressure or decreasing pressure (for example during hot filling, then during cooling of the liquid), the deformations of the membrane are thus localized on the groove or in the immediate vicinity thereof, while minimally affecting the rest of the facet.

According to a preferred embodiment, the groove extends parallel to the axis of the container.

The width of the groove is not necessarily constant. Preferably, the groove is widest at about two-thirds of its height and has for example a tapered profile.

In cross-section, the profile of the groove is preferably V-shaped, the facet—according to a particular embodiment—having a substantially flat outer face.

The ridge bordering the facet is, for example, formed by a fillet between the facet and an adjacent region.

According to a particular embodiment, the facet flares out from a middle region of the container to a shoulder or a bottom thereof.

The facet can form with an adjacent region a constant angle, which can be fixed (for example about45°), or variable (for example continuously variable). Thus, according to one embodiment, the angle decreases from an upper region of the container to a lower region of the container.

According to a particular embodiment, the container has two series of facets that are symmetrical with respect to a median transversal plane.

Other objects and advantages of the invention will be seen from the following description, with reference to the appended drawings in which:

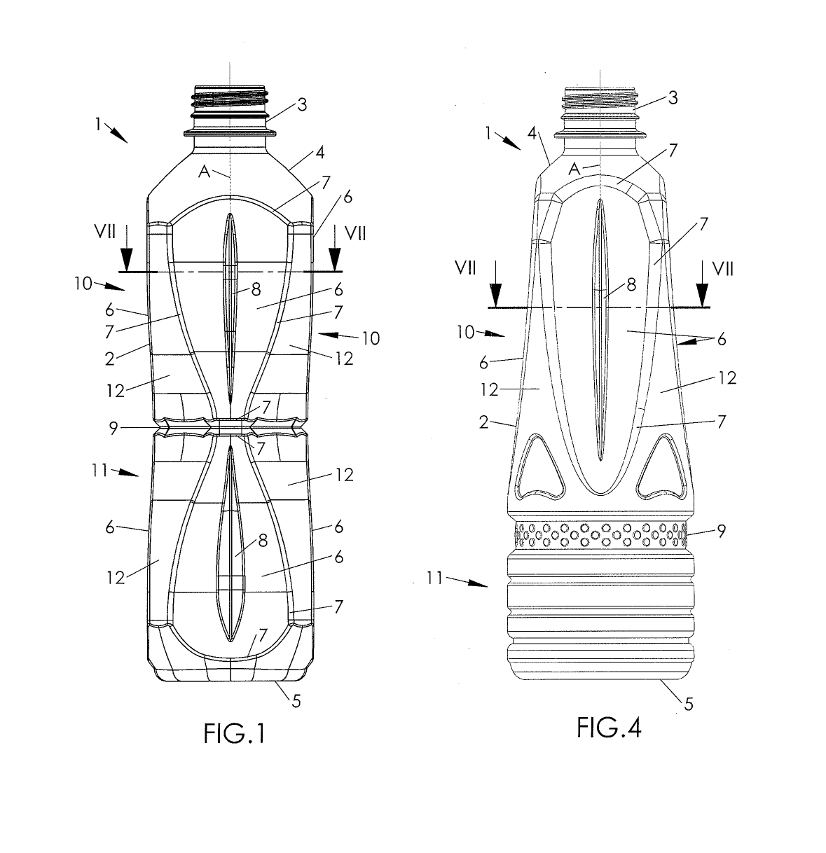

FIG. 1 is a front view of a first version of a container according to the invention;

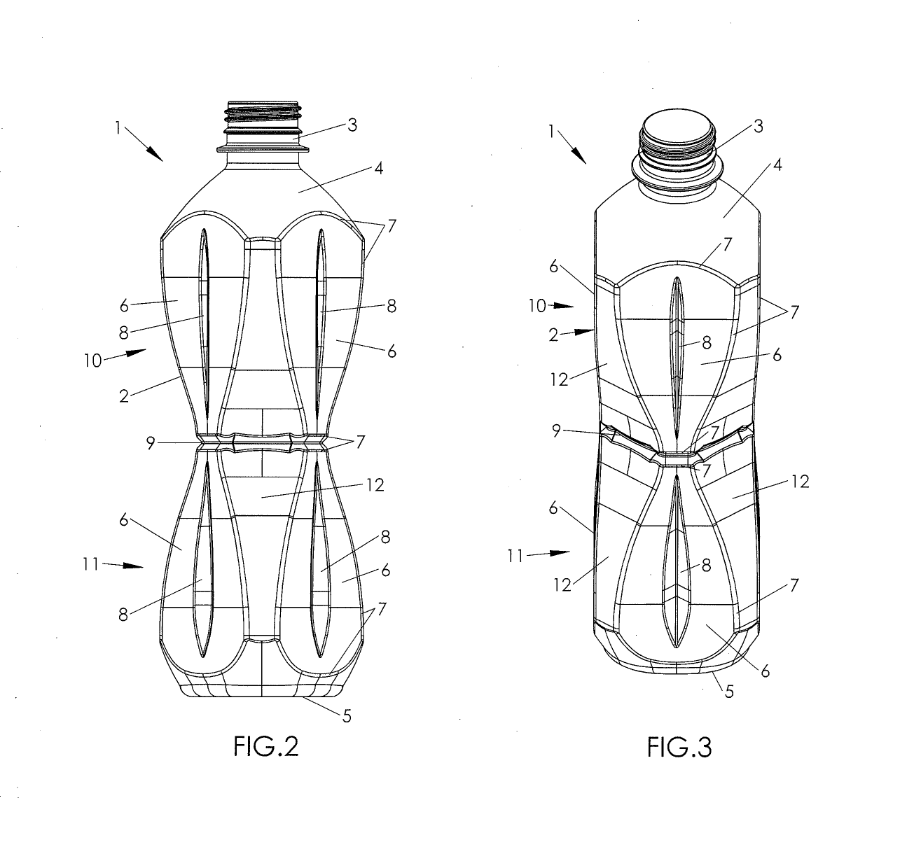

FIG. 2 is a three-quarters front view of the container of FIG. 1;

FIG. 3 is a top view in perspective of the container of FIGS. 1 and 2;

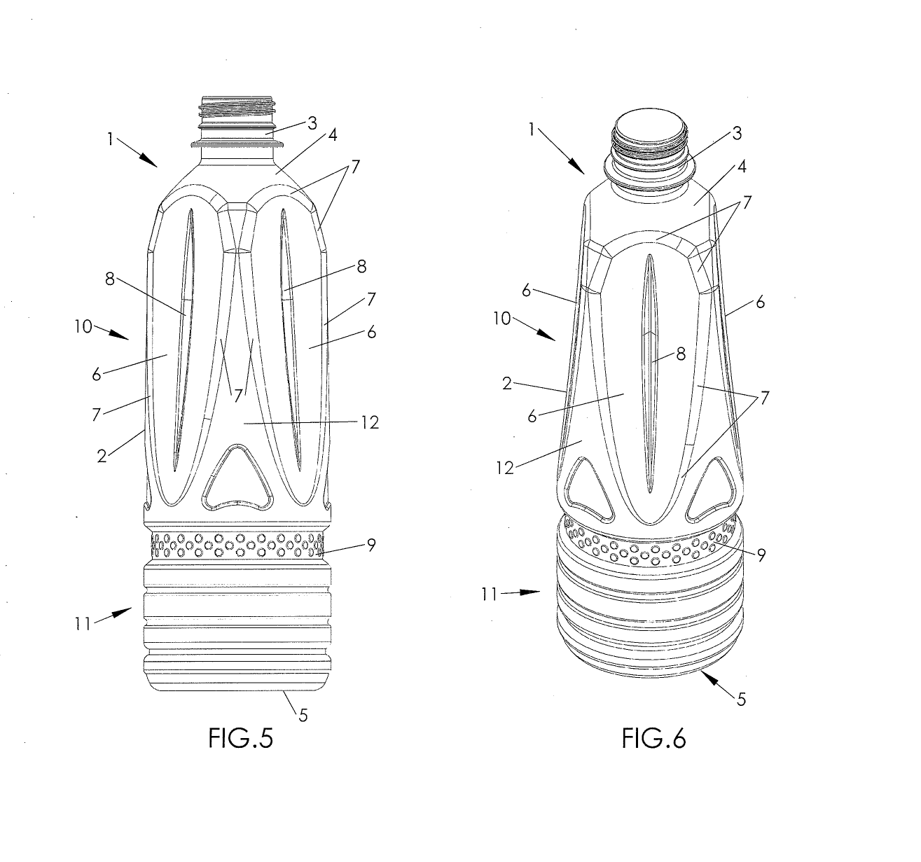

FIGS. 4 to 6 are similar views respectively to FIGS. 1 to 3, showing a second version of the container according to the invention;

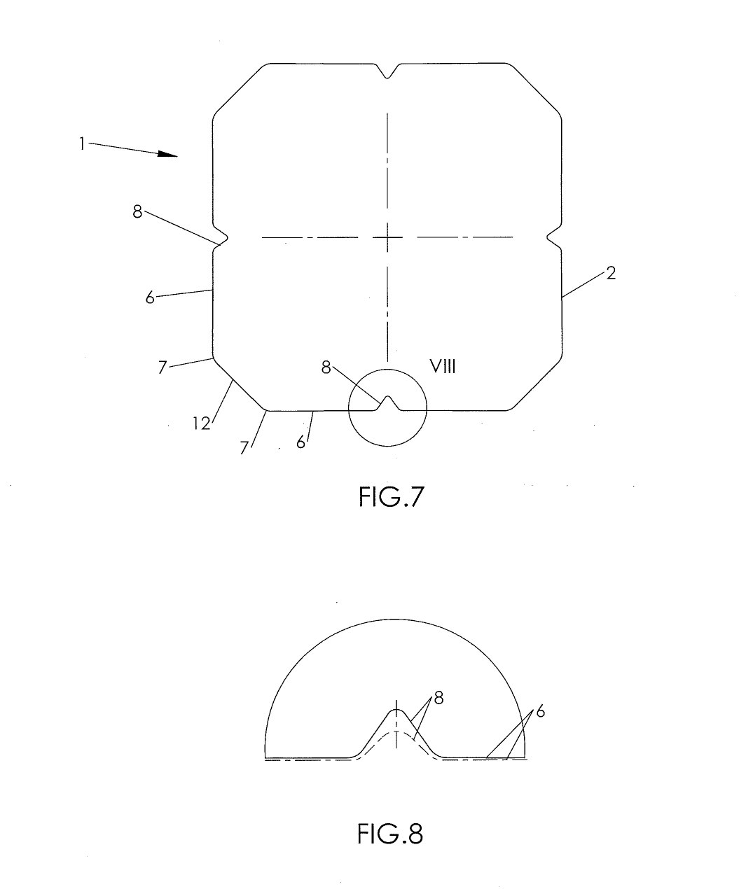

FIG. 7 is a view in transverse cross-section of a container of FIGS. 1 to 3 or 4 to 6, along the cutting plane shown in FIGS. 1 and 4 by lines VII-VII;

FIG. 8 is a view in transverse cross-section of a detail of the container of FIG. 7, at inset VIII, the dotted lines showing the deformation of the membrane during hot filling.

Represented in the figures is a container 1, in this instance a bottle made of plastic material such as PET with a capacity of 0.5 L, which comprises a plurality of parts, particularly a body 2 forming the major part of the volume of the container, a neck 3 opening upwards, a shoulder 4, completing the volume of the container 1 and forming a substantially conical junction between the body 2 and the neck 3, and finally, a bottom 5 that closes the body 2 downwards.

The container 1 extends along a principal axis A connecting approximately the geometric center of the neck 3 and that of the bottom 5. While assuming that the container 1 is intended to be placed flat on a horizontal surface, the axis A of the container defines a vertical direction, any direction orthogonal to the axis A being considered transversal or radial.

Said container 1, obtained by stretch-blowing from a blank (i.e., a preform or an intermediate container having undergone a first blowing that was not final) is particularly intended to be filled hot, the temperature of the fill liquid being able to reach 95° C., or a temperature that can exceed the glass transition temperature of the container 1, depending on its material. The glass transition temperature of PET is about 80° C.

Therefore, the container 1 is designed to have good mechanical strength during hot filling, and to sustainably preserve its shape during the subsequent cooling of the liquid.

More specifically, the body 2 of the container comprises at least one facet 6 defining a deformable membrane, which upon completion of the blowing has a substantially flat outer surface (not necessarily vertical, as we will see hereinafter).

The or each facet 6 is designed to be deformed first by bulging out when the container 1 is hot filled, under the combined effect of the hydrostatic pressure, which exerts a radial pressure on the facet 6, and of the temperature, which tends to soften the material.

Reciprocally, the facet 6 is designed to be deformed in a reverse way to substantially recover its original configuration (i.e., when coming out of blowing), accompanying the loss of internal volume of the container 1 resulting from the cooling of the liquid, said contraction not being able to be compensated by admission of air since the container is capped immediately after filling.

Contrary to the conventional arrangements in which the deformable character of panels is compensated by the addition of reinforcing beams intended to rigidify the container in the areas adjacent to the panels, the container 1 here has no beams, and each facet 6 is delimited by a single ridge 7 with closed contour, which forms the junction (also called fillet) between the facet 6 and the surrounding regions.

In order to obtain such a simplified—and thus lighter—structure, the deformations of the facet 6 are concentrated in a localized zone.

To that end, an oblong groove 8 is recessed into the facet 6. Said groove 8 has a V-shaped transverse profile. The shape of the groove 8, its orientation as well as its dimensions depend on those of the facet 6 into which it is recessed.

Two versions of the container 1 are represented in the figures: a first version is shown in FIGS. 1 to 3, a second version in FIGS. 4 to 6.

The first version has a body 2 with substantially square transverse cross-section. The body 2 is narrowed at a middle belt 9, constituting an additional part of the container 1, and which is substantially symmetrical with respect to the transverse plane of the belt 9. The body 2 also comprises a torso 10, which extends between the belt 9 and the shoulder 4, and a foot 11, which extends between the belt 9 and the bottom 5 and which, due to the symmetry mentioned above, is the mirror image of the torso 10 below the belt 9.

As can be seen in FIGS. 1 to 3, the torso 10 comprises a plurality of facets 6 equally distributed around its circumference. In this instance, there are four facets 6 distributed at 90°, but there could be fewer of them, for example three distributed at 120°, or more of them, for example five distributed at 72°.

Each facet 6 extends vertically between the belt 9 and the shoulder 4. The facet 6 flares out from the belt 9 to the shoulder 4 (respectively the bottom 5) and has the general shape of the blade of a paddle. Between two adjacent facets 6, the body 2 comprises separator faces 12 that are curved in the vertical direction (but are straight in transverse cross-section), which, contrary to the facets 6, become narrower from the belt 9 to the shoulder 4 (respectively the bottom 5).

The container 1 being thus contoured, the angle between each facet 6 and the regions surrounding it (i.e., the separator faces 12, the belt 9 and the shoulder 4—respectively the bottom 5) is about 45° from all parts. The radius of the fillet forming the ridge 7 of the facet 6 can be constant, as in this first version illustrated in FIGS. 1 to 3, or can vary in the vertical direction, the fillet being able to have, at the junctions between the facet 6 and the separator faces 12, a smaller radius at the belt 9 and comparatively larger at the shoulder 4—respectively the bottom 5.

The groove 8 extends vertically along a median axis of the facet 6. It extends substantially over the full height of the facet 6, its ends however being separated from the upper and lower edges of the facet 6. As can be seen in FIGS. 1 to 3, the width of the groove 8 is not constant. More specifically, the groove 8 is tapered, and from the front (see in particular FIG. 1) has a tapered contour. Moreover, the groove 8 is not necessarily symmetrical with respect to a transverse plane cutting it at its middle. In this instance, the groove 8 is widest at about two-thirds of its height, at the shoulder 4 (respectively the bottom 5) of the container 1.

Similarly, the depth of the groove 8 is not necessarily constant and preferably varies in proportion to its width. The angle that the flanks of the groove 8 form with the plane of the facet 6 is preferably constant, about 45°.

The second version of the container 1, illustrated in FIGS. 4 to 6, comprises a belt 9 forming a cylindrical restriction of the body 2, located in the lower part of the body 2, and separating said body from a torso 10 and a foot 11, the height of which is about one-half that of the torso 10.

The foot 11 is structured in a conventional manner, and comprises a series of cylindrical rolls separated by annular grooves that give the foot 11 good structural rigidity in the radial direction.

The facets 6 are situated in the torso 10. There are four facets 6 equally distributed at 90° around the circumference of the torso 10. As can be seen in FIGS. 4 to 6, each facet 6 forms a beveled panel that flares out from the belt 9 to the shoulder 4, having a bullet-shaped profile with the head pointing downwards. Each facet 6 extends in a substantially inclined plane with respect to the axis of the container 1.

Thus, in transverse cross-section, the container 1 has a substantially square shape (see FIG. 7), the diagonal of which is of a constant length along the vertical axis and equal to the diameter of the foot 11, while the length of the side of this square decreases progressively from the bottom—i.e., from the side of the belt 9—upwards—i.e., from the side of the shoulder 4.

Like the first version, the torso 10 comprises, between two adjacent facets 6, separator faces 12 that, contrary to the facets 6, become narrower from the belt 9 to the shoulder 4. However, the separator faces 12 of this second version have a substantially cylindrical transverse cross-section of substantially constant diameter, equal to the diameter of the container 1 measured at the junction of the torso 10 and the belt 9 or at the foot 11. It will be noted that, for the sake of simplicity, only one transverse cross-section is represented in FIG. 7 for both versions of container 1, the curvature of the separator faces 12 of the second version being slightly visible at the transverse cross-section VII-VII.

Because each facet 6 is inclined with respect to the axis of the container 1, the angle formed by the plane of the facet 6 with the regions surrounding it (the separator faces 12 and the shoulder 4) is not constant around the edge of the facet 6. Said angle is nearly flat (less than15°) at one lower end of the facet 6, at the belt 9; it is about 45° at an upper end of the facet 6, at its junction with the shoulder 4. The angle between the plane of the facet 6 and each separator face 12, on either side of the facet 6, varies continuously between these extreme values, decreasing upwards at the shoulder 4, downwards near the belt 9.

Like the first version, the radius of the fillet forming the ridge 7 of the facet 6 can be constant, or can vary along the vertical direction. In the example illustrated, the radius of the fillet is substantially constant, its width varying inversely to the angle between the plane of the facet 6 and the neighboring zones.

As can be seen in FIGS. 4 to 6, the groove 8 extends vertically along a median axis of the facet 6. It extends substantially over the whole height of the facet 6, its ends, however, being separated from the upper and lower edges. Like the first version, the width of the groove 8 is not constant: the groove 8 is tapered, and from the front has a tapered contour, and is widest at about two-thirds of its height, at the shoulder 4 of the container 1.

Similarly, the depth of the groove 8 is not constant and preferably varies in proportion to its width, the angle formed by the flanks of the groove 8 with the plane of the facet 6 being substantially constant, about 45°.

The performance of the two versions of the container 1 that have just been described is substantially the same during hot filling, then during the cooling of the liquid. As a result of the temperature of the liquid, combined with the hydrostatic pressure, the container 1 is first placed under pressure and tends to swell. The membrane thus tends to bulge outwards. However, due to the presence of the groove 8, the deformations of the facet 6 remain localized on or near the groove 8, which tends to flatten out, while the rest of the facet 6 preserves its overall flat shape (see FIG. 8). The deformation of the groove 8 is greatest at its widest place (in this instance at two-thirds of its height), i.e., at the widest part of the facet 6.

Reciprocally, during cooling of the liquid, the container 1 undergoes a decrease in pressure and a decrease of its internal volume, compensated by the reverse deformation of the membrane. Consequently, the groove 8 re-closes to its initial configuration, even slightly beyond due to the effect of the decreased pressure.

Thus, instead of providing the container 1 with deformable panels in a single block, surrounded by rigidifying beams (arrangements that consume material), here the facets 6 are delimited by simple ridges 7 that are not affected—or are only slightly affected—by the deformation. The result of such a structure is substantial gains in material: hot filling tests, for an equivalent capacity (in this instance 0.5 L), have made it possible to maintain the previous performance with respect to mechanical strength while reducing the weight of the container 1 (empty) by 15% to 20% (or a weight of less than 20 g for a capacity of 0.5 L). Such a container 1 can therefore be considered super-light.

As has already been indicated, the shape and orientation of the groove 8 can vary, particularly according to those of the facet 6. Indeed, it is preferable that the orientation of the groove 8 be identical to that of the facet 6. In both of the versions described above for example, the facet 6 extends (along its largest dimension) vertically, and it is the same with the groove 8. If the facet 6 were to have another orientation (for example horizontal, or even oblique), the groove 8 would extend in the same direction.

1. Container of thermoplastic material such as PET, having a body, said container being characterized in that the body comprises at least one facet defining a deformable membrane, delimited by a ridge with closed contour and forming a salient angle on the body, and in that an oblong groove is made in said facet.

2. Container according to claim 1, characterized in that the groove extends parallel to the axis of the container.

3. Container according to claim 1, characterized in that the width of the groove is not constant.

4. Container according to claim 3, characterized in that the groove is widest at about two-thirds of its height.

5. Container according to claim 1, characterized in that the groove has a tapered profile.

6. Container according to claim 1, characterized in that the groove has a V-shaped cross-section.

7. Container according to claim 1, characterized in that the facet has a substantially flat outer face.

8. Container according to claim 1, characterized in that the ridge is formed by a fillet between the facet and an adjacent part.

9. Container according to claim 1, characterized in that the facet flares out from a middle part of the container, such as a belt to a shoulder or a bottom thereof.

10. Container according to claim 1, characterized in that the facet forms with an adjacent part a constant angle.

11. Container according to claim 10, characterized in that the angle is about 45°.

12. Container according to claim 1, characterized in that the facet forms with an adjacent part a variable angle.

13. Container according to claim 12, characterized in that the angle is continuously variable.

14. Container according to claim 13, characterized in that the angle decreases from an upper region of the container towards a lower part of the container.

15. Container according to claim 1, characterized in that the container has two series of facets that are symmetrical with respect to a median transverse plane.
